(19) United States
(12) Patent Application Publication
(10) Pub. No.: US 2026/0332013 A1
(43) Pub. Date: Oct. 22, 2026

(54) LINEAR MOTOR AND ELECTRONIC DEVICE

(71) Applicant: GOERTEK INC., Weifang (CN)

(72) Inventors: Guojing ZHENG, Weifang (CN); Dongsheng MAO, Weifang (CN); Yuqing ZHANG, Weifang (CN)

(21) Appl. No.: 19/712,302

(22) Filed: Jun. 18, 2026

Related U.S. Application Data
(63) Continuation of application No. PCT/CN2025/109917, filed on Jul. 22, 2025.

(30) Foreign Application Priority Data
Nov. 29, 2024 (CN) 202411745144.X

(51) Int. Cl. H02K 33/18; H02K 33/02

(52) U.S. Cl. CPC H02K 33/18; H02K 33/02

(57) ABSTRACT

The present application provides a linear motor and an electronic device. The linear motor includes a housing with a receiving space, and an oscillator assembly, a stator assembly, and an elastic member disposed within the receiving space. The oscillator assembly includes a counterweight with a mounting cavity and a magnetic circuit structure fixed to the mounting cavity. The elastic member connects the housing and the counterweight to suspend the oscillator assembly in the receiving space. The stator assembly is fixedly connected to the housing and at least partially housed in the mounting cavity. The mounting cavity has two first cavity walls disposed opposite each other in a direction perpendicular to the vibration direction of the oscillator assembly. The magnetic circuit structure includes two magnet assemblies disposed on the two first cavity walls.

### CROSS-REFERENCE TO RELATED APPLICATIONS

The present application is a continuation application of International Application No. PCT/CN2025/109917, filed on Jul. 22, 2025, which claims priority to Chinese Patent Application No. 202411745144.X, entitled in “LINEAR MOTOR AND ELECTRONIC DEVICE” and filed on Nov. 29, 2024. The disclosures of the above-mentioned applications are incorporated herein by reference in their entireties.

### TECHNICAL FIELD

The present application relates to the technical field of linear motor, and in particular to a linear motor and an electronic device.

### BACKGROUND

In applications such as virtual reality (VR), augmented reality (AR), mobile phones, and tablets, linear motors are commonly used as vibration feedback units.

A linear motor is a device that converts electrical energy into mechanical energy using the principle of electromagnetic force generation. Generally, a linear motor structure includes an oscillator assembly suspended within a housing and a stator assembly fixed within the housing. The oscillator assembly includes a counterweight and a magnetic circuit structure fixed within a mounting cavity of the counterweight. At least a portion of the stator assembly is housed within the mounting cavity.

Currently, due to unreasonable magnetic circuit design or manufacturing defects, the magnetic field lines in a linear motor may not be completely enclosed within the magnetic circuit, and some magnetic field lines may leak to the outside of the magnetic circuit, resulting in magnetic leakage. Magnetic leakage affects the operating efficiency of the linear motor.

### SUMMARY

The main objective of the present application is to provide a linear motor and an electronic device, aiming to improve the efficiency of the linear motor.

To achieve the above objective, the linear motor proposed in the present application includes:
a housing, provided with a receiving space;
an oscillator assembly, including a counterweight and a magnetic circuit structure; the counterweight is provided with a mounting cavity, and the magnetic circuit structure is fixed to a cavity wall of the mounting cavity;
an elastic member; one end of the elastic member is connected to the housing, and the other end of the elastic member is connected to the counterweight, for suspending the oscillator assembly in the receiving space; and
a stator assembly, fixedly connected to the housing and at least partially received in the mounting cavity;
the mounting cavity is provided with two first cavity walls disposed opposite each other in a vibration direction perpendicular to the oscillator assembly; the magnetic circuit structure includes two magnet assemblies disposed on the two first cavity walls; each magnet assembly includes a central magnet and two side magnets disposed on opposite sides of the central magnet; a magnetic guide plate is disposed between the central magnet and the first cavity wall, and the side magnet is fixedly connected to the first cavity walls.

In an embodiment, in the vibration direction perpendicular to the oscillator assembly, a thickness of the side magnet is equal to a sum of a thicknesses of the central magnet and the magnetic guide plate.

In an embodiment, the thickness of the magnetic guide plate is less than or equal to half the thickness of the central magnet.

In an embodiment, an assembly gap is provided between the magnetic guide plate and the side magnet along the vibration direction of the oscillator assembly.

In an embodiment, the assembly gap is less than or equal to 0.05 mm.

In an embodiment, in the vibration direction perpendicular to the oscillator assembly, the thickness of the side magnet and the central magnet are the same; the counterweight is provided with a mounting groove communicating with the mounting cavity, and the mounting groove is configured for mounting the magnetic guide plate.

In an embodiment, magnetization directions of both the central magnet and the side magnet are perpendicular to the vibration direction of the oscillator assembly, and the magnetization directions of the central magnet and the side magnet are opposite.

In an embodiment, magnetization directions of opposing magnets in the two magnet assemblies are opposite.

In an embodiment, the mounting cavity further includes two second cavity walls disposed opposite to each other along the vibration direction, and each of the two second cavity walls is provided with a clearance groove.

The present application also provides an electronic device, including: the linear motor.

In the technical solution of the present application, a housing with receiving space is provided in the linear motor. An oscillator assembly, an elastic member, and a stator assembly are installed within the receiving space. The oscillator assembly includes a counterweight with a mounting cavity and a magnetic circuit structure fixed to the mounting cavity. The elastic member suspends the oscillator assembly in the receiving space. The stator assembly is fixedly connected to the housing and at least partially housed within the mounting cavity. The mounting cavity has two first cavity walls arranged opposite each other in a direction perpendicular to the vibration direction of the oscillator assembly. The magnetic circuit structure includes two magnet assemblies disposed on the two first cavity walls. Each magnet assembly includes a central magnet and two side magnets disposed on opposite sides of the central magnet. A magnetic guide plate is provided between the central magnet and the first cavity wall, and the side magnets are fixedly connected to the first cavity wall. Thus, compared to the related art where the magnet assemblies are directly connected to the cavity walls of the mounting cavity, the present application provides a magnetic guide plate between the central magnet and the first cavity wall, thereby improving the effective utilization rate of the magnetic field lines, reducing magnetic leakage, and improving the efficiency of the linear motor.

### BRIEF DESCRIPTION OF THE DRAWINGS

In order to more clearly illustrate the technical solutions in the embodiments of the present application or the related art, the drawings required for use in the embodiments or the related art description will be briefly introduced below. Obviously, for those skilled in the art, other drawings can be obtained based on these drawings without creative labor.

FIG. 1 is a partial structural schematic diagram of a linear motor according to an embodiment of the present application.

FIG. 2 is a cross-sectional diagram of FIG. 1.

The realization of the objective, functional features and advantages of the present application will be further explained in conjunction with the embodiments and with reference to the accompanying drawings.

### DETAILED DESCRIPTION OF THE EMBODIMENTS

The technical solutions of the embodiments of the present application will be clearly and completely described below with reference to the accompanying drawings. Obviously, the described embodiments are only a part of the embodiments of the present application, and not all of them. All other embodiments obtained by those skilled in the art based on the embodiments of the present application without creative effort are within the protection scope of the present application.

It should be noted that if the embodiments of the present application involve directional indications (such as up, down, left, right, front, back, etc.), these directional indications are only used to explain the relative positional relationship and movement of the components in a specific posture. If the specific posture changes, the directional indications will also change accordingly.

Furthermore, if the embodiments of the present application involve descriptions such as “first”, “second” etc., these descriptions are only for descriptive purposes and should not be construed as indicating or implying their relative importance or implicitly specifying the number of technical features indicated. Therefore, features defined with “first” or “second” may explicitly or implicitly include at least one of those features. Furthermore, the use of “and/or” throughout the text implies three parallel solutions. For example, “A and/or B” includes solution A, solution B, or a solution satisfying both A and B simultaneously. Additionally, the technical solutions of the various embodiments can be combined, but this must be based on the ability of those skilled in the art to implement them. If the combination of technical solutions is contradictory or impossible to implement, it should be considered that such a combination does not exist and is not within the protection scope claimed by the present application.

In applications such as virtual reality (VR), augmented reality (AR), mobile phones, and tablets, linear motors are commonly used as their vibration feedback units.

A linear motor is a device that converts electrical energy into mechanical energy using the principle of electromagnetic force generation. Generally, the structure of a linear motor includes an oscillator assembly suspended within a housing and a stator assembly fixed within the housing. The oscillator assembly includes a counterweight and a magnetic circuit structure fixed within a mounting cavity of the counterweight. At least a portion of the stator assembly is housed within the mounting cavity.

Currently, due to unreasonable magnetic circuit design or manufacturing defects, the magnetic field lines in linear motors may not be completely enclosed within the magnetic circuit, with some lines leaking to the outside, resulting in magnetic leakage. Magnetic leakage not only affects the operating efficiency of the linear motor but also generates additional electromagnetic interference, adversely affecting surrounding electronic equipment.

The present application proposes a linear motor.

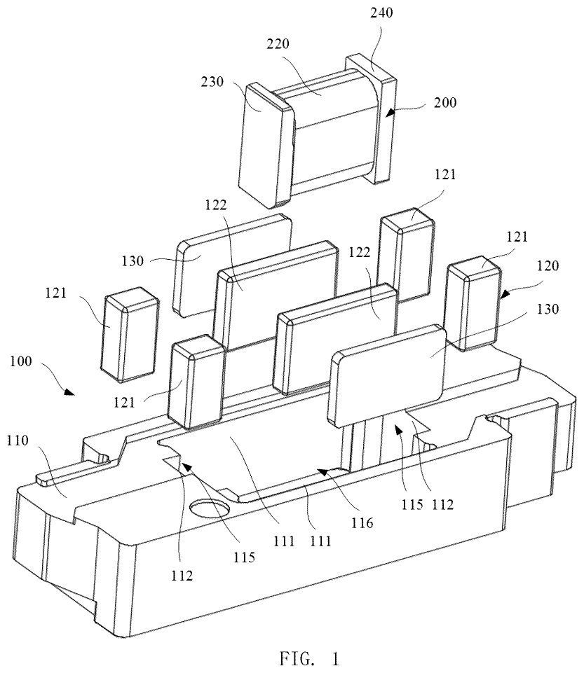

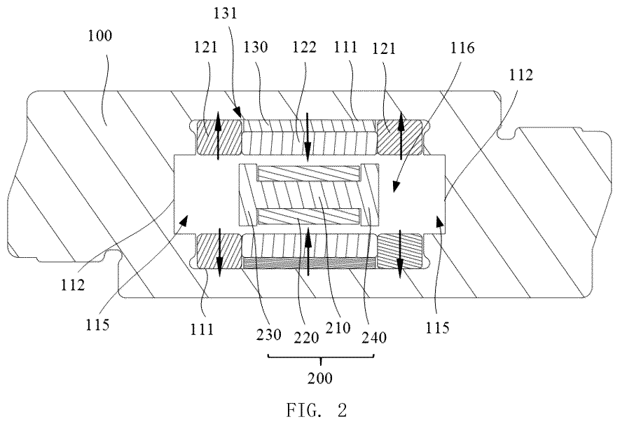

Referring to FIGS. 1 and 2, in an embodiment of the present application, the linear motor includes a housing, an oscillator assembly 100, an elastic member, and a stator assembly 200. The housing has a receiving space, within which the oscillator assembly 100, the elastic member, and the stator assembly 200 are all disposed. The oscillator assembly 100 includes a counterweight 110 and a magnetic circuit structure 120. The counterweight 110 has a mounting cavity 116, and the magnetic circuit structure 120 is fixed to the cavity wall of the mounting cavity 116. The two ends of the elastic member are connected to the housing and the counterweight 110, respectively, to suspend the oscillator assembly 100 in the receiving space. The stator assembly 200 is fixedly connected to the housing and at least partially housed in the mounting cavity 116.

Understandably, the oscillator assembly 100 is suspended in the housing space, meaning it does not directly contact the housing. The stator assembly 200 includes an iron core 210 and a coil 220. The iron core 210 is fixedly connected to the inner wall of the housing, and the coil 220 is wound around the surface of the iron core 210. In an embodiment, the stator assembly 200 further includes a first magnetic pole shoe 230 and a second magnetic pole shoe 240 respectively fixed to the ends of the iron core 210. When the coil 220 is energized, the first magnetic pole shoe 230 and the second magnetic pole shoe 240 are subsequently magnetized. Thus, when the linear motor operates, the coil 220 is energized to generate a magnetic field, and the iron core 210 generates an Ampere force under the action of the magnetic field. The counterweight 110 reciprocates under the action of the Ampere force generated by the stator assembly 200.

The mounting cavity 116 has two first cavity walls 111 arranged opposite each other in the vibration direction perpendicular to the oscillator assembly 100. The magnetic circuit structure 120 includes two magnet assemblies disposed on the two first cavity walls 111. Each magnet assembly includes a central magnet 122 and two side magnets 121 disposed on opposite sides of the central magnet 122. A magnetic guide plate 130 is provided between the central magnet 122 and the first cavity walls 111, and the side magnets 121 are fixedly connected to the first cavity walls 111.

For ease of explanation, the vibration direction of the oscillator assembly 100 is defined as the left-right direction; the vibration direction perpendicular to the oscillator assembly 100 is defined as the front-back direction; and the direction of the stator assembly 200 toward and away from the mounting cavity 116 is defined as the up-down direction. In the front-to-back direction, the mounting cavity 116 has two opposing first cavity walls 111. Two magnet assemblies are respectively mounted on the first cavity walls 111. In the embodiment shown in the figures of the present application, the two magnet assemblies are symmetrically arranged; that is, the central magnet 122 on one first cavity wall 111 is opposite to the central magnet 122 on the other first cavity wall 111, and the side magnet 121 on one first cavity wall 111 is opposite to the side magnet 121 on the other first cavity wall 111.

It is understood that the magnetic guide plate 130 can concentrate the magnetic field generated by the magnet assemblies, improve the effective utilization rate of the magnetic field lines, reduce magnetic leakage, and thus improve the efficiency of the linear motor. It also achieves electromagnetic shielding, reducing electromagnetic interference to surrounding electronic equipment. Furthermore, the magnetic guide plate 130 is only located at the central magnet 122, thus avoiding occupying more magnet mounting space, avoiding reducing the thickness of the magnet assembly, and thus avoiding reducing the driving force of the linear motor. It also avoids occupying more space in the mounting cavity 116, thus avoiding reducing the mass of the counterweight 110, thereby ensuring the vibration effect of the linear motor.

In the technical solution of the present application, a housing with receiving space is provided in the linear motor. An oscillator assembly 100, an elastic member, and a stator assembly 200 are installed in the receiving space. The oscillator assembly 100 includes a counterweight 110 with a mounting cavity 116 and a magnetic circuit structure fixed to the mounting cavity 116. The elastic member is used to suspend the oscillator assembly 100 in the receiving space. The stator assembly 200 is fixedly connected to the housing and at least partially received in the mounting cavity 116. The mounting cavity 116 has two first cavity walls 111 arranged opposite to each other in the vibration direction perpendicular to the oscillator assembly 100. The magnetic circuit structure includes two magnet assemblies disposed on the two first cavity walls 111. The magnet assemblies include a central magnet 122 and two side magnets 121 disposed on opposite sides of the central magnet 122. A magnetic guide plate 130 is provided between the central magnet 122 and the first cavity wall 111. The side magnets 121 are fixedly connected to the first cavity wall 111. Therefore, compared to the related art where the magnet assembly is directly connected to the cavity wall of the mounting cavity 116, the present application provides a magnetic guide plate 130 between the central magnet 122 and the first cavity wall 111, thereby improving the effective utilization rate of the magnetic field lines, reducing magnetic leakage, and increasing the efficiency of the linear motor.

In an embodiment of the present application, in the vibration direction perpendicular to the oscillator assembly 100, the thickness of the side magnet 121 is equal to the sum of the thicknesses of the central magnet 122 and the magnetic guide plate 130.

It is understood that there must be a gap between the magnet assembly and the stator assembly 200 to prevent contact interference between the oscillator assembly 100 and the stator assembly 200. Thus, in an embodiment, the inner walls of the side magnet 121 and the central magnet 122 are flush. This facilitates setting the gap between the magnet assembly and the stator assembly 200 and also helps to ensure the thickness of the magnet assembly, thereby ensuring the driving force of the linear motor.

In the embodiment shown in the figures of the present application, the thickness of the side magnet 121 is the same as the sum of the thicknesses of the central magnet 122 and the magnetic guide plate 130. Thus, the inner wall of the side magnet 121 is flush with the inner wall of the central magnet 122, and the outer wall of the side magnet 121 is flush with the outer wall of the magnetic guide plate 130. This facilitates the setting of the mounting cavity 116 on the counterweight 110 and simplifies the processing and forming of the counterweight 110.

In an embodiment of the present application, the thickness of the magnetic guide plate 130 is less than or equal to half the thickness of the central magnet 122. It is understood that the thicker the magnet, the stronger the driving force of the linear motor. To avoid affecting the driving force of the linear motor, the thickness of the magnetic guide plate 130 is less than or equal to half the thickness of the central magnet 122. This ensures both the driving force of the linear motor and improves the effective utilization rate of the magnetic field lines.

In an embodiment of the present application, an assembly gap 131 provided between the magnetic guide plate 130 and the side magnet 121 along the vibration direction of the oscillator assembly 100. This assembly gap 131 facilitates the installation of the magnetic circuit structure 120 and improves the assembly efficiency of the linear motor. In an embodiment, the assembly gap is less than or equal to 0.05 mm. In another embodiment, the magnetic guide plate 130 and the side magnet 121 can also be directly attached. The size of the assembly gap 131 is not limited here.

In an embodiment of the present application, in the vibration direction perpendicular to the oscillator assembly 100, the side magnet 121 and the central magnet 122 have the same thickness. The counterweight 110 has a mounting groove communicating with the mounting cavity 116, which is used for mounting the magnetic guide plate 130.

It is understood that, in an embodiment, the side magnet 121 and the central magnet 122 have the same thickness, and the outer wall of the central magnet 122 is also fitted with the magnetic guide plate 130. Thus, compared to the side magnet 121, the magnetic guide plate 130 protrudes outward. The counterweight 110 has a mounting groove communicating with the mounting cavity 116, and the magnetic guide plate 130 is mounted on the groove wall. This also allows for the installation of the magnetic circuit structure 120 and the magnetic guide plate 130.

In this embodiment of the present application, the magnetization directions of the center magnet 122 and the side magnet 121 are both perpendicular to the vibration direction of the oscillator assembly 100. This allows the magnetic field lines to form a denser closed loop, thereby reducing magnetic leakage in the vertical direction of the magnet assembly, thus improving the efficiency of the linear motor and reducing additional electromagnetic interference. The magnetization directions of the center magnet 122 and the side magnet 121 are opposite. Thus, on the one hand, the adjacent center magnet 122 and the side magnet 121 have opposite magnetization directions, allowing the magnetic field lines to form a denser closed loop, thereby reducing magnetic leakage in the vertical direction of the magnet assembly, thus improving the efficiency of the linear motor and reducing additional electromagnetic interference. On the other hand, the magnetization directions of the adjacent central magnet 122 and the side magnet 121 are opposite, which improves the effective utilization rate of the magnetic field lines, facilitates the reciprocating vibration of the counterweight 110, and increases the driving force of the linear motor.

In an embodiment of the present application, the magnetization directions of the opposing magnets in the two magnet assemblies are opposite; that is, the magnetization directions of the central magnets 122 in the two magnet assemblies are opposite, and the magnetization directions of the opposing side magnets 121 in the two magnet assemblies are opposite. This ensures that the forces exerted by the two magnet assemblies on the coil 220 are in the same direction, thereby increasing the driving force.

In the scheme shown in the figures of the present application, the magnetization directions of the magnet assemblies are defined as follows:

The magnetization direction of the side magnet 121 is from the inner wall of the side magnet 121 to the outer wall of the side magnet 121;

The magnetization direction of the central magnet 122 is from the outer wall of the central magnet 122 to the inner wall of the central magnet 122.

In an embodiment, the projection of the central magnet 122 falls on the stator assembly 200 along the vibration direction perpendicular to the oscillator assembly 100. Specifically, along the left-right direction, the length of the stator assembly 200 is greater than or equal to the length of the central magnet 122, thus allowing the stator assembly 200 to directly interact with the side magnets 121, which is beneficial for improving the driving force of the linear motor.

In an embodiment of the present application, the mounting cavity 116 also has two second cavity walls 112 arranged opposite each other along the vibration direction, and both second cavity walls 112 are provided with avoidance grooves 115. It can be understood that the avoidance grooves 115 increase the vibration space of the oscillator assembly 100, avoid collisions between the stator assembly 200 and the second cavity walls 112 during linear motor vibration, improve the stability of the linear motor, and improve the reliability of the electronic device.

The present application also proposes an electronic device including a linear motor. The specific structure of the linear motor is as described in the above embodiments. Since this electronic device adopts all the technical solutions of all the above embodiments, it at least has all the beneficial effects brought about by the technical solutions of the above embodiments, which will not be repeated here. The electronic devices may include mobile phones, smart glasses, smart rings, smartwatches, etc.

The above descriptions are only some embodiments of the present application, and does not limit the patent scope of the present application. All equivalent structural transformations made by configuring the contents of the present application specification and drawings under the technical concept of the present application, or directly/indirectly applied in other related technical fields, are included in the patent protection scope of the present application.

What is claimed is:

1. A linear motor, comprising:
a housing, provided with a receiving space;
an oscillator assembly, comprising a counterweight and a magnetic circuit structure, wherein the counterweight is provided with a mounting cavity, and the magnetic circuit structure is fixed to a cavity wall of the mounting cavity;
an elastic member, wherein one end of the elastic member is connected to the housing, and the other end of the elastic member is connected to the counterweight, for suspending the oscillator assembly in the receiving space; and
a stator assembly, fixedly connected to the housing and at least partially received in the mounting cavity;
wherein the mounting cavity is provided with two first cavity walls disposed opposite each other in a vibration direction perpendicular to the oscillator assembly; the magnetic circuit structure comprises two magnet assemblies disposed on the two first cavity walls; each magnet assembly comprises a central magnet and two side magnets disposed on opposite sides of the central magnet; a magnetic guide plate is disposed between the central magnet and the first cavity wall, and the side magnet is fixedly connected to the first cavity walls.

2. The linear motor according to claim 1, wherein in the vibration direction perpendicular to the oscillator assembly, a thickness of the side magnet is equal to a sum of a thicknesses of the central magnet and the magnetic guide plate.

3. The linear motor according to claim 2, wherein the thickness of the magnetic guide plate is less than or equal to half the thickness of the central magnet.

4. The linear motor according to claim 1, wherein an assembly gap is provided between the magnetic guide plate and the side magnet along the vibration direction of the oscillator assembly.

5. The linear motor according to claim 4, wherein the assembly gap is less than or equal to 0.05 mm.

6. The linear motor according to claim 1, wherein in the vibration direction perpendicular to the oscillator assembly, the thickness of the side magnet and the central magnet are the same; the counterweight is provided with a mounting groove communicating with the mounting cavity, and the mounting groove is configured for mounting the magnetic guide plate.

7. The linear motor according to claim 1, wherein magnetization directions of both the central magnet and the side magnet are perpendicular to the vibration direction of the oscillator assembly, and the magnetization directions of the central magnet and the side magnet are opposite.

8. The linear motor according to claim 7, wherein magnetization directions of opposing magnets in the two magnet assemblies are opposite.

9. The linear motor according to claim 1, wherein the mounting cavity further comprises two second cavity walls disposed opposite to each other along the vibration direction, and each of the two second cavity walls is provided with a clearance groove.

10. An electronic device, comprising: the linear motor according to claim 1.
